(19) United States
(12) Patent Application Publication
(10) Pub. No.: US 2013/0294059 A1
(43) Pub. Date: Nov. 7, 2013

(54) LED LIGHT FIXTURE

(71) Applicants: Gregory Galluccio, Hauppauge, NY (US); Francisco Schapira, Valley Stream, NY (US); Ruel Sarino, Port Washington, NY (US); Carlos Salazar, North Babylon, NY (US)

(72) Inventors: Gregory Galluccio, Hauppauge, NY (US); Francisco Schapira, Valley Stream, NY (US); Ruel Sarino, Port Washington, NY (US); Carlos Salazar, North Babylon, NY (US)

(73) Assignee: LEVITON MANUFACTURING COMPANY, INC., Melville, NY (US)

(21) Appl. No.: 13/463,928

(22) Filed: May 4, 2012

(51) Int. Cl. F21V 29/00; F21V 17/00; F21V 21/00; F21V 7/00; F21S 4/00

(52) U.S. Cl. 362/218; 362/217.05; 362/223; 362/217.1; 362/217.02; 29/401.1

(57) ABSTRACT

LED light fixtures and methods of manufacturing same are provided. In one embodiment, a LED fixture assembly includes at least one cover configured to be disposed in a fluorescent light troffer, the at least one cover including at least one first cavity and a second cavity; at least one LED lamp module disposed in the first cavity; and a driver module disposed in the second cavity such that the driver module is visibly concealed and electrically coupled to at least one LED lamp module. Various embodiments of LED lamp modules have also been provided and are configured to provide light via direct and/or indirect lighting methods.

### TECHNICAL FIELD

The present disclosure generally relates to light fixtures, and more particularly relates to light emitting diode (LED) light fixtures and methods of manufacturing LED light fixtures.

### BACKGROUND

Fluorescent lamp holders are typically installed in an enclosure or fixture housing with a ballast and associated wiring. The manufacturer will generally assemble the lamp holders to the sheet metal fixture, attach the ballast to the fixture, and run wires between the ballast and lamp holders. This process can be labor intensive and may lead to wiring errors and an unappealing installation.

FIG. 13 is a top view of a conventional fluorescent light fixture 250. The fluorescent light fixture 250 may include an enclosure 252, which may be a fixture housing, also known as a troffer. Surface 254 of the enclosure 252 may be a reflector. The surface 254 may have breaks in slope 256 to direct light in selected directions. The fluorescent light fixture 250 may include lamp holders 258, 260, and 262. The lamp holders 258, 260, and 262 may each hold one end of a tube-type fluorescent lamp. The other end of each lamp may be held by lamp holders 264, 266, and 268, respectively. Arrows A, B, and C show where fluorescent tubes would be placed between corresponding lamp holders. The lamp holders 258, 260, and 262 are connected to a first ballast 270 and lamp holders 264, 266, and 268 are connected to a second ballast 272. Ballasts 270 and 272 are fixed directly to enclosure 252.

FIG. 14 is a front view of a conventional fluorescent lamp holder 280. The conventional fluorescent lamp holder 280 may represent any of the lamp holders 258, 260, 262, 264, 266, or 268 and may include a view of lamp holder 260 indicated by the arrows shown in FIG. 13. As illustrated, the lamp holder 280 includes a base 282, body 284, lamp pin guide 286, and pin slot 288. Paired contact pins from a fluorescent lamp may be inserted into pin slot 288 until the pins occupy positions 290 and 292. The pins may then be rotated in directions A and R, along pin guide 286, about rotational axis X until the pins contact power terminals 294 and 296 (shown in broken lines) inside the body 284 of the fluorescent lamp holder 280.

Technology currently exists for replacing standard linear fluorescent lamps with tubular shaped LED lamps that have similar form, fit, and function to the linear fluorescent lamps. These tubular LED lamps may suffer from certain common performance issues. Generally, the light output of the LED tubes may be substandard as compared to the linear fluorescent tubes due to the constraints on the shape of the tubes. The longevity of some of these LED lights is often compromised because the driver circuitry contained in the tube creates the need for additional heat sinking. If either one of the LED array or the driver circuitry fails, the entire LED tube, which includes both the LED array and driver circuitry, must be replaced. In addition, LED retrofit/replacement tubes often use the existing linear fluorescent sockets as connection means, resulting in possible drawbacks. Some drawbacks include but are not limited to: lamps falling out of fixtures due to the increased weight of LED tubes, improperly wired sockets, customer replacement of LED tubes with standard linear fluorescent tubes after the fixture has been rewired to accept only LED tubes, and other issues.

It would be helpful to develop a system to mitigate some of the problems with retrofitted fluorescent light fixtures.

### SUMMARY

The present disclosure describes various implementations of LED light fixtures and systems for modifying a fluorescent light fixture into a fixture that is able to illuminate LED lamps.

According to one aspect of the present disclosure, a light emitting diode (LED) lamp module is provided including an elongated housing having a first end and a second end, the housing including a first wall and first and second side walls extending substantially perpendicular from at least a portion of the first wall, each of the first and second side walls including a flange portion extending toward an opposing side wall and being generally parallel to the first wall, the flange portions defining a slot or opening along the housing; and at least one LED disposed on an inner side of each of the flange portions, the at least one LED facing the first wall such that light is transmitted from the at least one LED towards the first wall and at least partially reflected out of the LED lamp module through the opening. Optionally, a diffuser may be disposed across the opening and coupled to each of the flange portions.

According to another aspect of the present disclosure, a light emitting diode (LED) fixture assembly includes at least one cover configured to be disposed in a fluorescent light troffer, the at least one cover including at least one first cavity and a second cavity; at least one LED lamp module disposed in the at least one first cavity; and a driver module disposed in the second cavity such that the driver module is visibly concealed and electrically coupled to at least one LED lamp module, the driver module configured to provide electrical power to the at least one LED lamp module, wherein the second cavity includes a removable portion for providing access to the driver module disposed therein.

According to a further aspect of the present disclosure, a method of retrofitting an existing fluorescent light troffer to a light emitting diode (LED) light fixture is provided, the method includes providing removing one or more fluorescent tube lamp holders and a ballast from the existing fluorescent light troffer ; mounting at least one cover in the fluorescent light troffer, the cover including at least one first cavity and a second cavity; mounting a driver module in the second cavity for electrically coupling the driver module to at least one LED lamp module, the driver module being visibly concealed within the second cavity of the cover when mounted, the driver module configured to provide electrical power to the at least one LED lamp module; and inserting the at least one LED lamp module disposed in the at least one first cavity.

### BRIEF DESCRIPTION OF THE DRAWINGS

The features illustrated in the following figures are intended to emphasize the general principles of the present disclosure and are not necessarily drawn to scale. Consistent reference characters are used throughout the figures to designate corresponding features.

FIG. 1 is a perspective view of a LED lamp module, according to various implementations of the present disclosure.

FIG. 2 is a cross sectional view of the LED lamp module shown in FIG. 1 taken along line 2-2, according to various implementations of the present disclosure.

FIG. 3 is another cross sectional view of the LED lamp module shown in FIG. 2 taken along line 3-3, according to various implementations of the present disclosure.

FIG. 4A is a perspective view of a first end cap for a LED lamp module, according to various implementations of the present disclosure.

FIG. 4B is a perspective view of a second end cap for a LED lamp module, according to various implementations of the present disclosure.

FIG. 5 is a diagram illustrating a perspective view of an LED light fixture, according to various implementations of the present disclosure.

FIG. 6 is a diagram illustrating a top view of a conventional fluorescent light fixture housing.

FIG. 7A is a right perspective view of the LED fixture shown in FIG. 5 with the LED lamp modules removed, according to various implementations of the present disclosure.

FIG. 7B is a left perspective view of the LED fixture shown in FIG. 5 with the LED lamp modules removed, according to various implementations of the present disclosure.

FIG. 8A is a perspective view of a lamp holder, according to various implementations of the present disclosure.

FIG. 8B is a perspective view of another lamp holder, according to various implementations of the present disclosure.

FIG. 9 is a perspective view of a cover of a LED light fixture assembly, according to various implementations of the present disclosure.

FIG. 10A is an exploded view of a LED light fixture assembly, according to one implementation of the present disclosure.

FIG. 10B is a bottom view of the cover shown in FIG. 10A, according to one implementation of the present disclosure.

FIG. 11 is an exploded view of a LED light fixture assembly, according to another implementation of the present disclosure.

FIG. 12A is a perspective view of another LED lamp module, according to various implementations of the present disclosure.

FIG. 12B is a cross sectional view of the LED lamp module shown in FIG. 12A taken along line 12B-12B, according to various implementations of the present disclosure.

FIG. 13 is a diagram illustrating a top view of a conventional fluorescent light fixture.

FIG. 14 is a diagram illustrating a front view of a conventional fluorescent lamp holder.

### DETAILED DESCRIPTION

The present disclosure describes light emitting diode (LED) lamps, LED light fixtures, lamp holders, and systems for modifying standard fluorescent light fixtures to accommodate LED lamp modules. According to some embodiments, the LED lamp modules and LED light fixture assemblies may each contain distinct lighting features to allow the components to be separately replaceable. In this way, the cost to replace defective parts may be reduced since only the parts that are no longer functional are replaced.

In some embodiments, the LED lamp modules may be installed into an enclosure or fixture housing designed to fit in a standard ceiling grid or other similar ceiling-mounted down-lighting fixture. The LED lamp modules are able to provide LED light in a pattern, color, and intensity similar to or superior to that of a standard linear fluorescent fixture of the same size. As disclosed herein, the LED light fixtures include LED lamp modules that are illuminated by LED driver circuits that may or may not be located in the LED light fixture assemblies. The LED lamp module of the present disclosure will include one or more LED's mounted to a printed circuit board or similar structure and placed into an enclosure that may or may not include additional optics and that does not include the driver circuitry within the enclosure. If one or the other of the LED lamps or LED driver circuits becomes inoperative, the non-functioning part can be replaced without the need to replace the part that remains operational.

The LED lamp modules, according to various implementations disclosed herein, help to mitigate some of the problems with retrofitted fluorescent light fixtures. For example, some embodiments herein comprise driver circuitry that is contained in a module separate from the LED light arrays or lamp module and is therefore replaceable and does not contribute heat to the light arrays. The LED light arrays can be manufactured to take on any shape that fits in the existing fixture space, and are not restricted to tubular shapes emulating T8 or T5 fluorescent lamps. This allows a lighting designer to create a better overall light output (compared to existing LED tubes) using existing fixtures. For holding the weight of the LED lamp modules, lamp holders are positioned at each end of the LED lamp modules. The lamp holders provide sufficient support to reduce the possibility of LED lamp modules falling out due to vibration or other unintentional disturbance. In some embodiments, the lamp holders may be designed in a way such that a standard fluorescent lamp will not be able to fit into the lamp holders.

It should be recognized in the present disclosure that certain relative terms, such as “top,” “bottom,” “left,” and “right” are used to refer to the orientation of the objects as shown in the drawings. However, the orientation of certain objects as suggested by the terminology may differ from the actual orientation when the light fixtures are mounted. For example, a light fixture may be mounted on a horizontal ceiling, a slanted ceiling, a vertical wall, or on other surfaces having various orientations. In the case of a downward directed light fixture mounted to a horizontal ceiling, a top section of an object as shown may actually be directed downward when installed in the fixture.

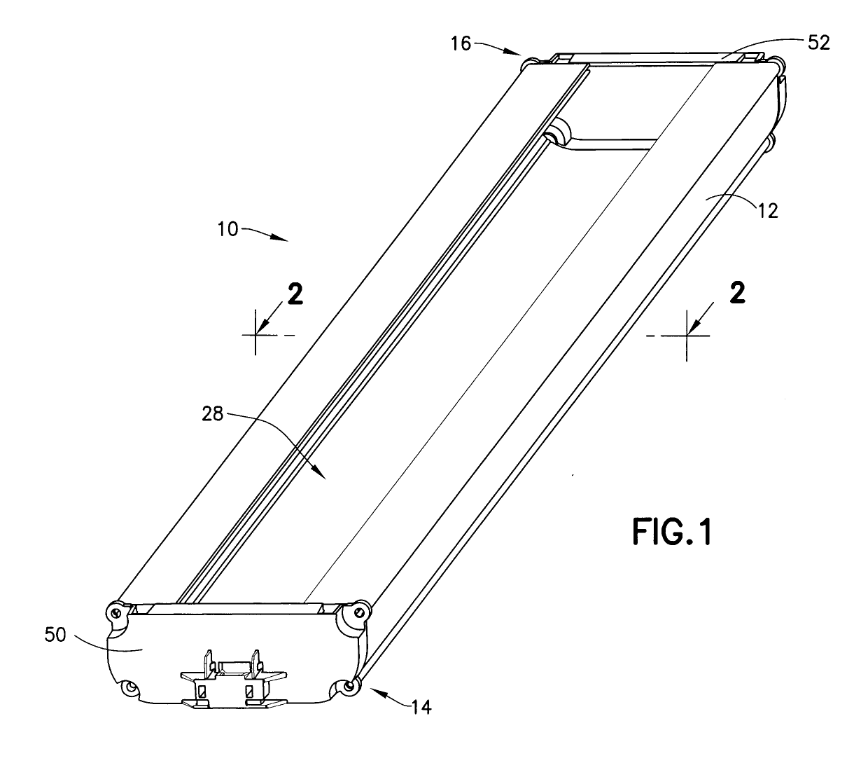

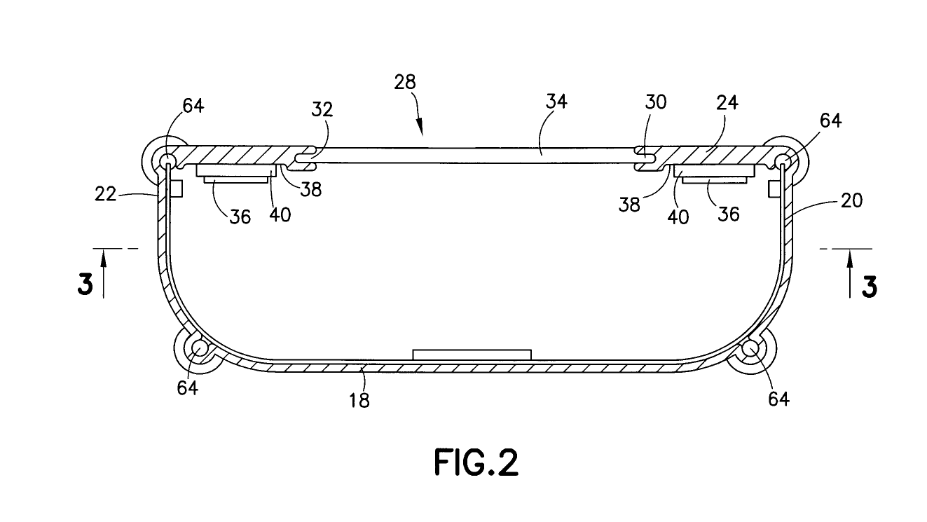

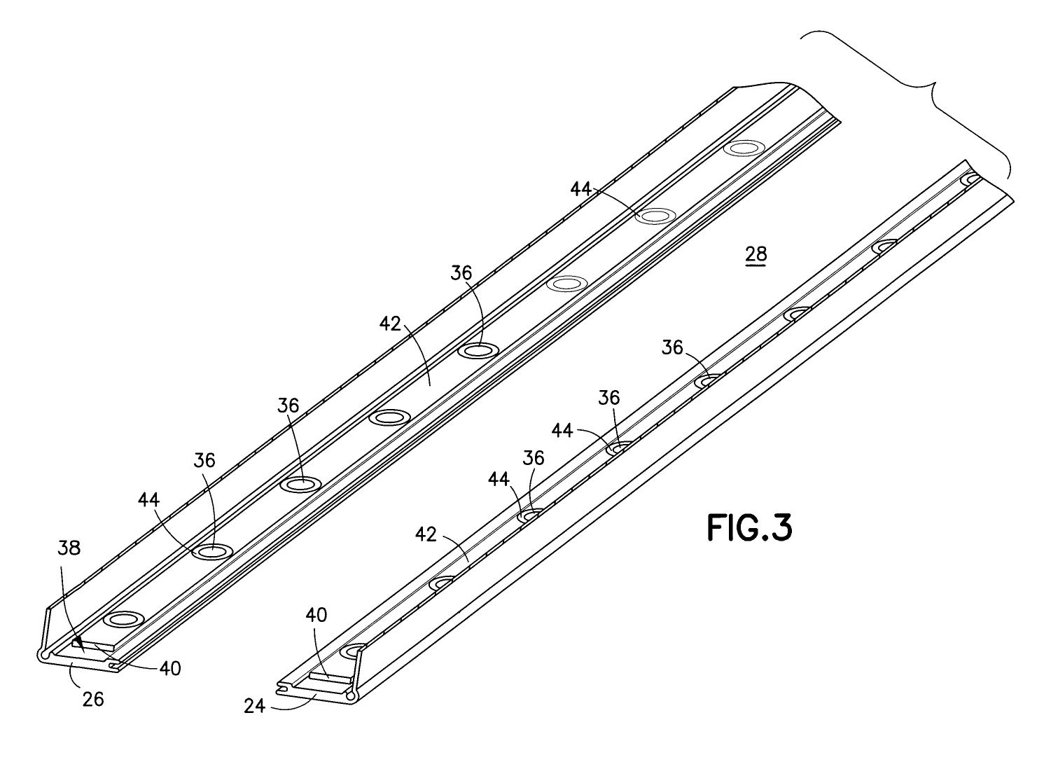

FIGS. 1-4C are diagrams that show a first embodiment of an LED lamp module 10. In this embodiment, the LED lamp module 10 includes an elongated housing 12 having a first end 14 and a second end 16. The elongated housing 12 includes a bottom or first wall 18 and first and second side walls 20,22 extending perpendicular from the first wall 18. Each of the first and second side walls 20, 22 include a flange portion 24, 26 respectively extending toward an opposing side wall and being generally parallel to the first wall 18. The flange portions 24, 26 define a slot or opening 28 along the housing 12.

Each flange portion 24, 26 includes a U-shaped channel 30, 32 respectively running along the length of the housing 12. A diffuser 34 may be disposed across the slot or opening 28 and coupled to each of the U-shaped channels 30, 32 of flange portions 24,26. Opposing edges of the planar diffuser 34 is disposed in each U-shaped channel 30, 32 of flange portions 24,26. The diffuser 34 may contain transparent or translucent material and may be configured to enclose a number of LED elements 36 within the housing 12 and to diffuse the light emitted from the LED elements.

The internal surfaces of the housing 12 may include a reflective material for indirectly reflecting light emitted by the LEDs 36 through the diffuser 34. It is to be appreciated that the housing 12 may be constructed from any known reflective material, and therefore, the internal surfaces of the housing 12 are reflective. Additionally, the housing 12 may be constructed of a non-reflective material with a reflective material disposed thereon via any known process.

At least one LED 36 is disposed on an underside or inner side 38 of each of the flange portions 24,26, where the at least one LED 36 is positioned to face the bottom wall 18. It is to be appreciated that the LED elements may be configured as at least one array of LED elements. In one embodiment, a plurality of LEDs 36 are disposed in a linear arrangement along the underside 38 of each of the flange portions 24,26. The plurality of LEDs 36 are disposed on a printed circuit board 40 which is coupled to the underside 38 of each of the flange portions 24,26 via thermal tape or other similar method 42. The thermal tape 42 includes a aperture 44 corresponding to each of the plurality of LEDs 36. The thermal tape 42 is placed over the printed circuit board 40 containing the plurality of LEDs 36 to secure the printed circuit board 40 to the underside 38 of each of the flange portions 24,26. In one implementation, the upper surface of the thermal tape 42 will include a reflective surface to aid in directing light emitted by the LEDs away from the LEDs.

The housing 12 of the LED lamp 10 may be of a unitary construction, for example, extruded from a single material or formed from a single piece of sheet metal. In one implementation, the housing is constructed from a material having thermal conductive properties, where the housing will act as a heat sink for the LEDs. Alternatively, housing 12 does not need to be of a unitary construction and my be composed of discrete parts.

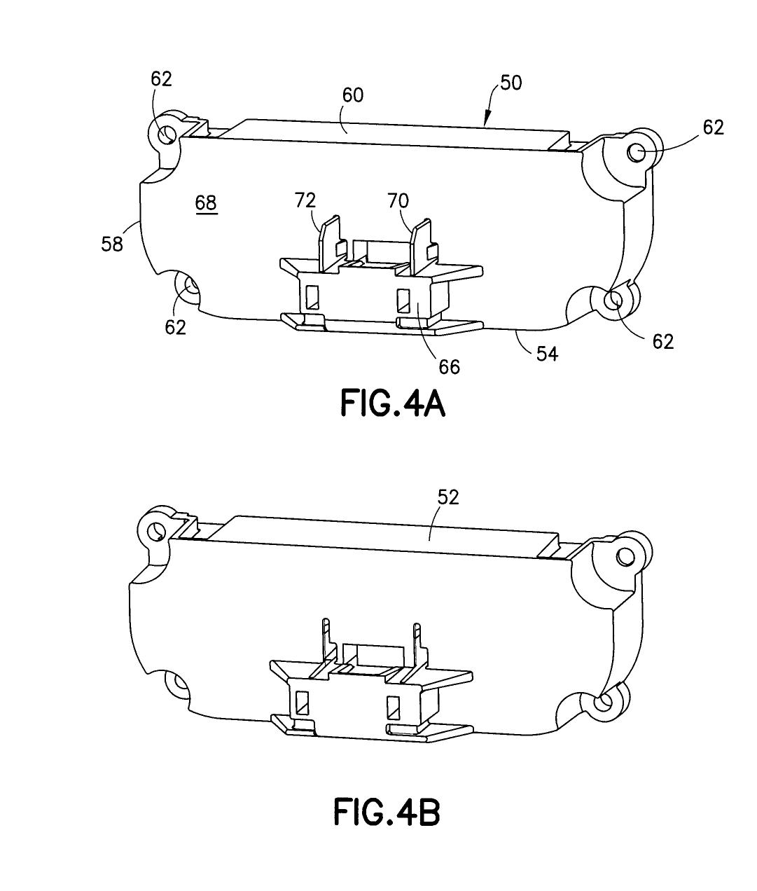

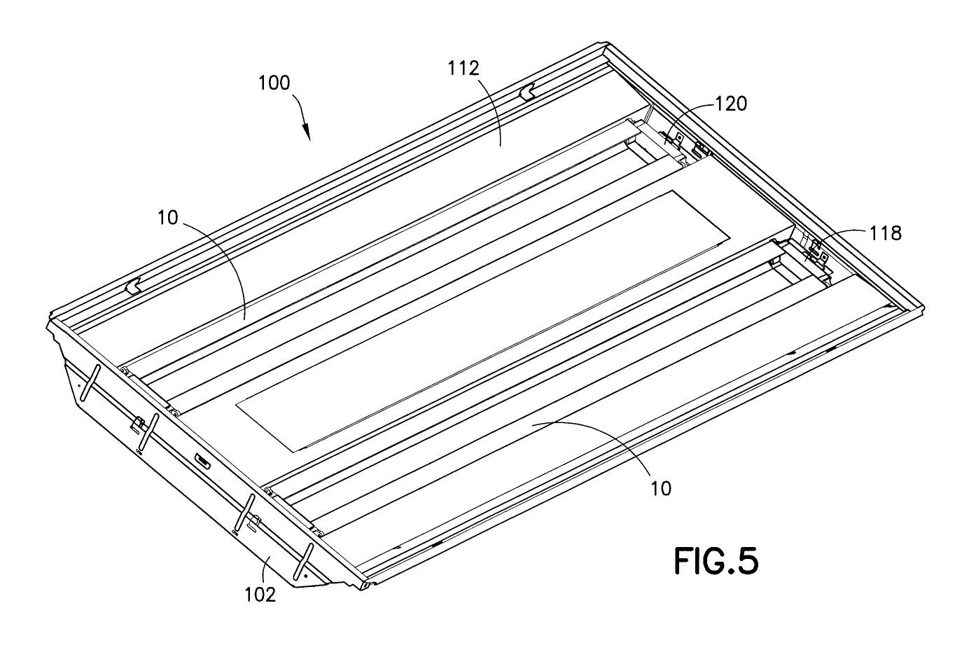

The first end 14 of the LED lamp 10 includes a first end cap 50 and the second end 16 includes a second end cap 52. As shown in FIG. 4A, the first end cap 50 is configured to mate with the first end 14 of the housing 12 and includes a bottom wall 54, first and second side walls 56, 58 and a top wall 60. The first end cap 50 further includes apertures 62 which correspond to apertures 64 of the housing 12. The apertures 62 are configured to receive a fastener for securing the first end cap 50 to the first end 14 of the housing 12.

A guide member 66 extends from a back wall 68 of the first end cap 50. The guide member 66 may be used to engage with a support structure, e.g., a lamp holder, a support strip, a power supply strip, etc., as described in more detail below. In one embodiment, the guide member will further include blades 70 and 72. The blades 70 and 72 will be formed from non-conductive material and will be employed primarily for support. In another embodiment, the blades 70 and 72 will be formed from conductive material coupled to the at least one LED 36 and will provide electrical power to the LED lamp module 10 when coupled to a lamp holder containing the appropriate circuitry.

Referring to FIG. 4B, the second end cap 52 is illustrated. The second end cap 52 is of substantially the same construction as the first end cap 50. In FIG. 4B, the guide member 66 does not include blades. It is to be appreciated that the LED lamp module 10 will in certain implementations, only require one end cap to have conducting blades for powering the LEDs contained therein. In other implementations, both the first and second end caps 50, 52 will include conducting blades for powering various LEDs contained within the LED lamp 10.

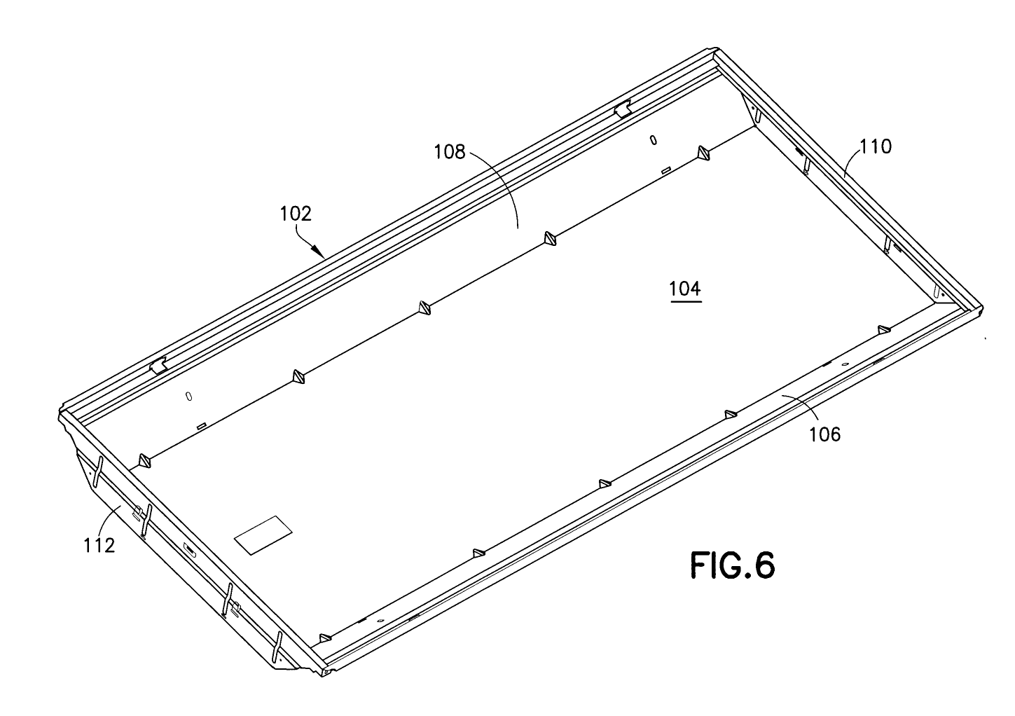

FIG. 5 is diagram illustrating an embodiment of an LED light fixture 100, which may be configured to support the LED lamp module 10 of FIG. 1. In this embodiment, the LED light fixture 100 comprises a housing 102, also known as a troffer, that may be similar to a conventional housing of a fluorescent light fixture. According to some implementations, the LED light fixture 100 may be manufactured from new parts and may be designed to resemble a conventional fluorescent light fixture, yet accept LED lamp modules.

However, according to other implementations, the LED light fixture 100 may be constructed from a conventional fluorescent light fixture that has been modified for illuminating LED lamps, including but not limited to LED lamp module 10, instead of fluorescent lamps. In this respect, the light fixture 100 may be a retrofitted fluorescent light fixture. When retrofitted, the ballasts of the fixture are unnecessary and may be removed. Also, the conventional lamp holders may be replaced with lamp holders that are configured to accommodate LED lamps or lamp modules.

As illustrated in FIG. 6, the housing 102 of the LED light fixture 100 includes a back surface or plate 104, first side plate 106, second side plate 108, a first end plate 110 disposed at a first end portion, and a second end plate 112 disposed at a second end portion. The plates 104-112 may be metal or another suitable material and may be connected together by any means now known or hereafter developed, including for example by welding or other connection techniques. The LED light fixture 100 may have any suitable size and shape. Also, the LED light fixture 100 may be configured to provide structural support for holding one or more LED lamp modules. The light fixture 100 may also be configured with electrical contacts for providing electricity to a properly mounted LED lamp module.

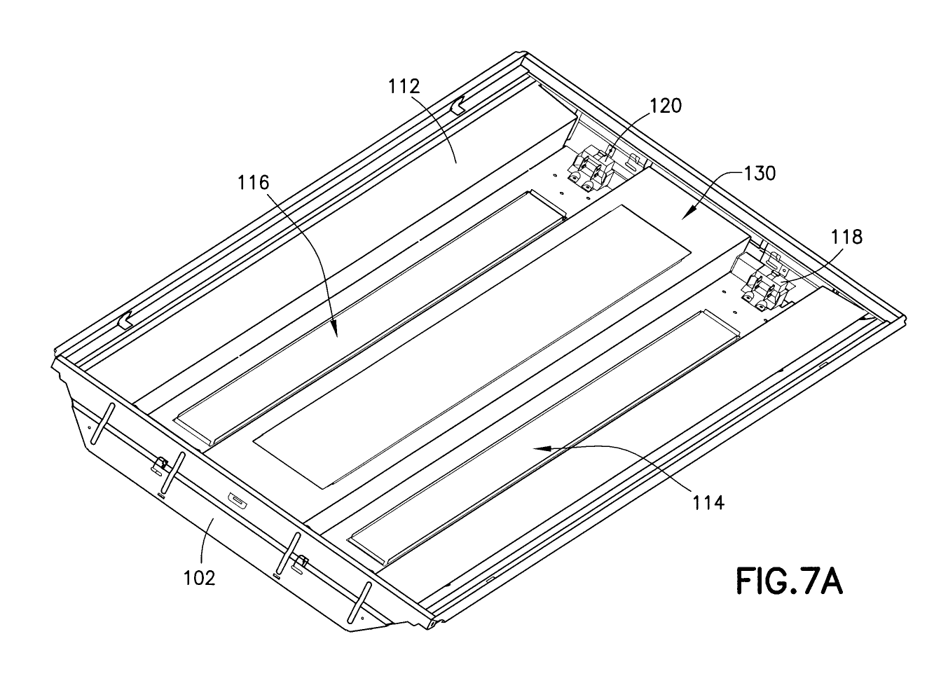

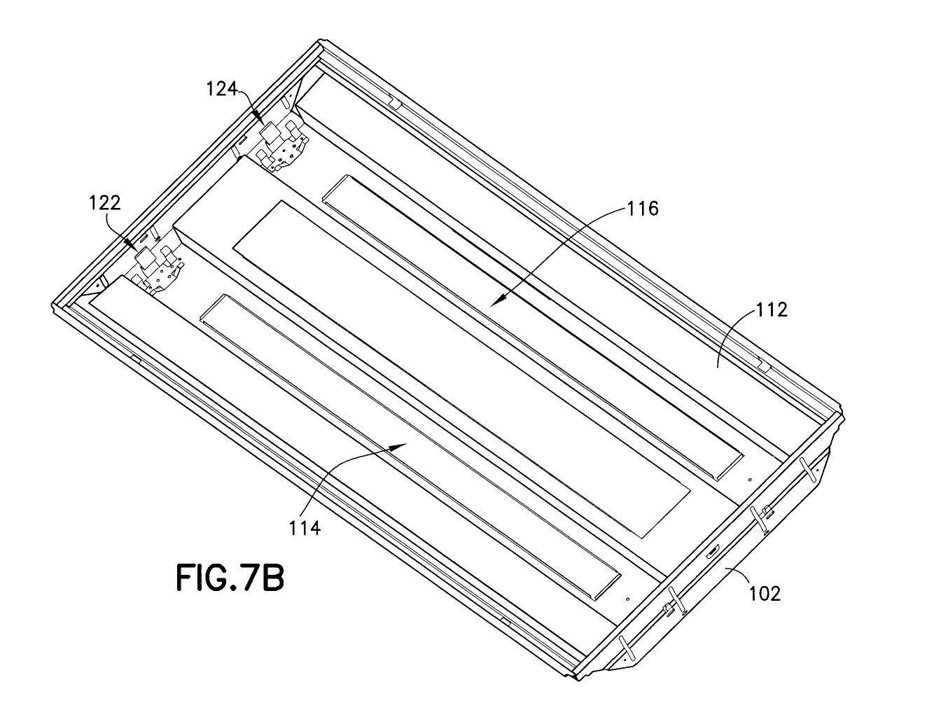

As shown is FIGS. 7A and 7B, the LED light fixture 100 includes a cover 112 that may be affixed to the housing 102. The cover 112 includes at least one exposed cavity 114, 116 configured for receiving a LED lamp module. The cover 112 in this embodiment includes a first lamp holder 118 and a second lamp holder 120. The first lamp holder 118 and second lamp holder 120 may be configured to physically support a first end of the LED lamp module and provide electricity to the LED lamp module. The cover 112 also includes a corresponding lamp holder or lamp holders 122, 124 disposed at an end opposite from the first and second lamp holders 118, 120. The corresponding lamp holder or lamp holders 122, 124 may be similar to lamp holders 118, 120 or may comprise a different design for holding the other end of the LED lamp module 10. The corresponding lamp holder or lamp holders may differ from the lamp holders 118, 120 in that electrical power may be applied to the LED lamp module 10 via the lamp holders 118, 120. It is to be appreciated that when lamp holders similar to lamp holders 122, 124 are provided at both the first end and second end of the cover 112, power to the LED lamp module 10 will be provided through other means, e.g., a wired connection to the LED lamp module 10. The first and second ends of the cover 112 include the same number of lamp holders to support a certain number of LED lamp modules 10. According to various embodiments, first and second ends of the cover 112 may each have any suitable number of lamp holders for supporting any number of lamps or lamp modules.

The exposed cavities 114, 116 may have any suitable width to accommodate the width of the LED lamp modules. For example, in one embodiment, the width of the exposed cavity may be just slightly larger than the width of the housing of the LED lamp module. In some embodiments, the cover 112 may include three or more exposed cavities, each cavity configured to support a single LED lamp module.

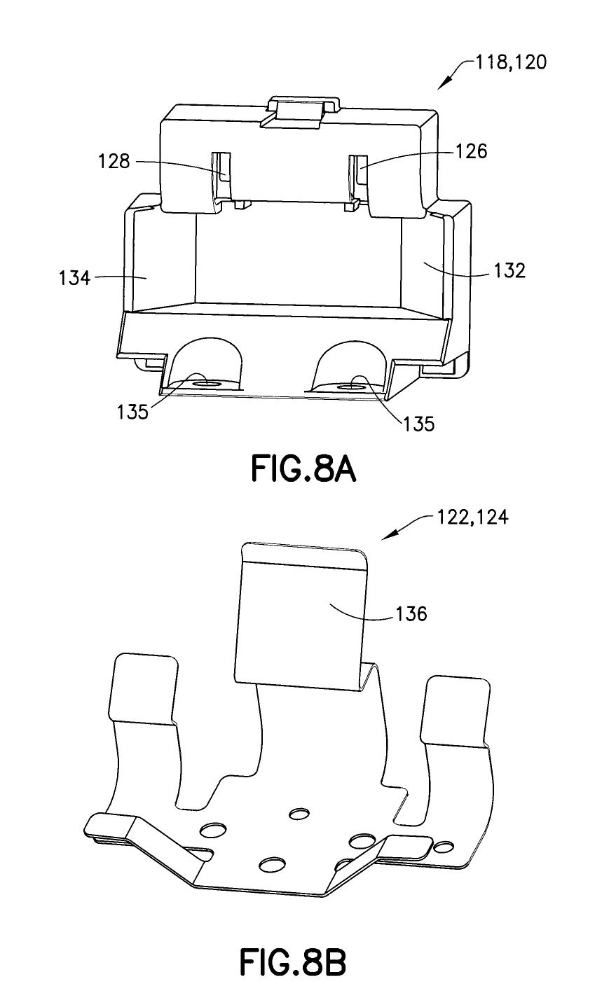

As shown in FIGS. 7A and 8A, each lamp holder 118, 120 is configured to receive guide member 66 of the first end cap 50. Each lamp holder 118, 120 includes a right receptacle 126 and a left receptacle 128. The receptacles 126, 128 may have openings large enough to allow the blades 70 and 72 of the LED lamp module 10 to be inserted through the openings. In this embodiment, the lamp holders include two receptacles, although in other embodiments three or more receptacles may be provided. One or more electrically conductive contacts are positioned inside the receptacles and are configured to provide electrical power and/or control signals to the LED lamp module 10. The cover 112 further may include at least one driver module 130 configured to carry electricity to the receptacles 126, 128 for electrically driving the LED lamp module 10. The lamp holders 118 also includes alignment blocks 132, 134 configured to align the guide member 66 of the LED lamp 10 such that the blades 70, 72 may be inserted in the receptacles 126, 128. Additionally, the lamp holders 118, 120 include apertures 135 configured for receiving a fastener to secure the lamp holder 118, 120 to the cover 112.

It is to be appreciated that although FIGS. 1 and 4A show two blades 70, 72 the illustration is only an example and the LED lamp module 10 may have more or less than two blades depending on the functionality of the LED lamp module 10. For example, in one embodiment, first and second electrically conductive blades or contacts are provided to provide power to the LED lamp module. A third electrically conductive blade or contact may provide a ground potential to the LED lamp module. Fourth and fifth electrically conductive blades or contacts provide control signals to the LED lamp module. In other embodiments, a ground pin or contact may not be provided and the third, fourth and fifth electrically conductive blades or contacts provide control signals to the LED lamp module. The control signals may be provided to control color, color temperature, and brightness of light emitted from LED elements of the LED lamp.

Referring to FIGS. 7B and 8B, another embodiment of corresponding lamp holder or lamp holders 122, 124 is illustrated. The lamp holder 122, 124 is configured to receive the guide member 66 of the second end cap 52 and physically support the weight of the end of the LED lamp module 10. Lamp holders 122, 124 include a latch 136 configured to releasably lock or secure the LED lamp module 10 in place. The latch 136 may be moved or flexed to allow the guide member 66 to be removed from the lamp holder 122.

It is to be appreciated that the lamp holders 118, 120 or 122, 124 and/or end caps 50, 52 may be provided with a means for securing the LED lamp module 10 to the cover 112 to prevent easy removal or theft of the LED lamp module 10. In one implementation, the lamp holders and/or end caps include an aperture for receiving a fastener which will be securely fixed to the cover 112. Other implementations are contemplated and considered to be within scope of the present disclosure.

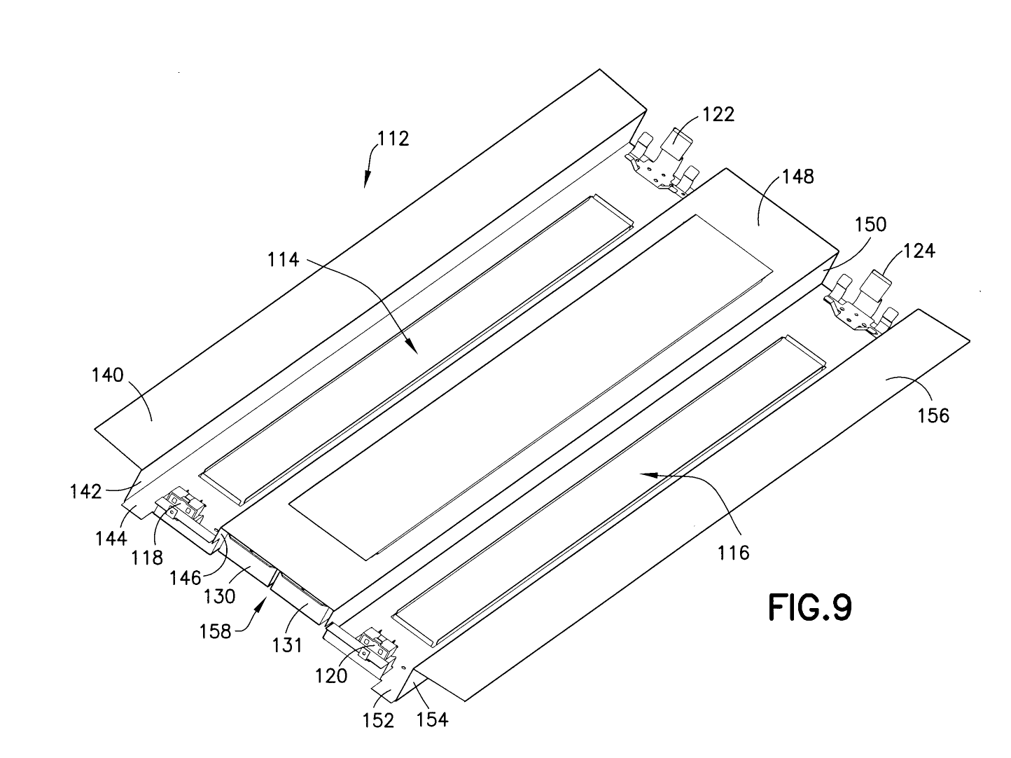

FIG. 9 illustrates an embodiment of the cover 112 in greater detail with the housing 102 and LED lamp modules 10 removed. The cover 102 includes a first wing surface or plate 140, first side plate 142, a bottom plate 144, a second side plate 146, a central connector plate 148, a third side plate 150, a second bottom plate 152, a fourth side plate 154 and a second wing surface or plate 156. The plates 140-156 may be metal or another suitable material and may be connected together by any means now known or hereafter developed, including for example by welding or other connection techniques. Furthermore, the cover 112 may be formed from a single unitary material, e.g., a sheet metal, which may be manipulated by various known techniques to the desired configuration. The cover 112 may have any suitable size and shape.

As shown in FIG. 9, the first side plate 142, the first bottom plate 144 and the second side plate 146 form the first exposed cavity 114. Similarly, the third side plate 150, a second bottom plate 152, a fourth side plate 154 form the second exposed cavity 116. Furthermore, the second side plate 146, central connector plate 148 and third side plate 150 form a concealed cavity 158 for containing at least one driver module 130 and other circuitry. In the embodiment shown in FIG. 9, two driver modules 130, 131 are provided. Driver module 130 is electrically coupled to lamp holder 118 for providing power and/or control signals to a LED lamp module 10 disposed in cavity 114, i.e., the driver module 130 is coupled to a contact disposed in receptacle 126, 128. Likewise, driver module 131 is electrically coupled to lamp holder 118 for providing power and/or control signals to a LED lamp module 10 disposed in cavity 116. In certain embodiments, one driver module is provided for a corresponding one LED lamp module. In other embodiments, one driver module may be provided to be coupled to two or more LED lamp modules.

The concealed cavity 158 of the cover 112 may also include batteries serving as backup power to the fixture, and an emergency power control circuit for controlling backup power. In addition, concealed cavity 158 may also include any type of occupancy sensor, daylight sensor, dimmer or other control circuit that may be used in conjunction with the LED lamp modules. In certain embodiments when an occupancy sensor, daylight sensor, etc. is employed, at least a portion of the sensor will be mounted and/or exposed on the central connector plate 148 so the sensor may sense conditions external to the concealed cavity 158 and/or surrounding the fixture 100. In addition, concealed cavity 158 may alternately or additionally include any suitable components in any suitable combination as will be appreciated by those skilled in the art.

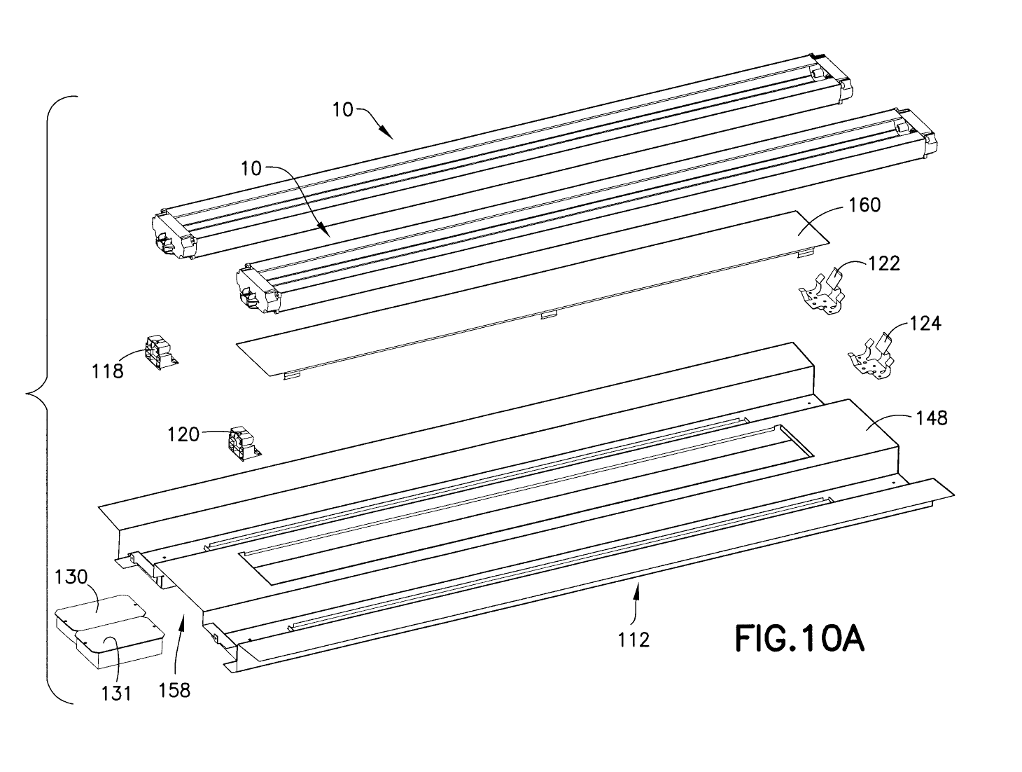

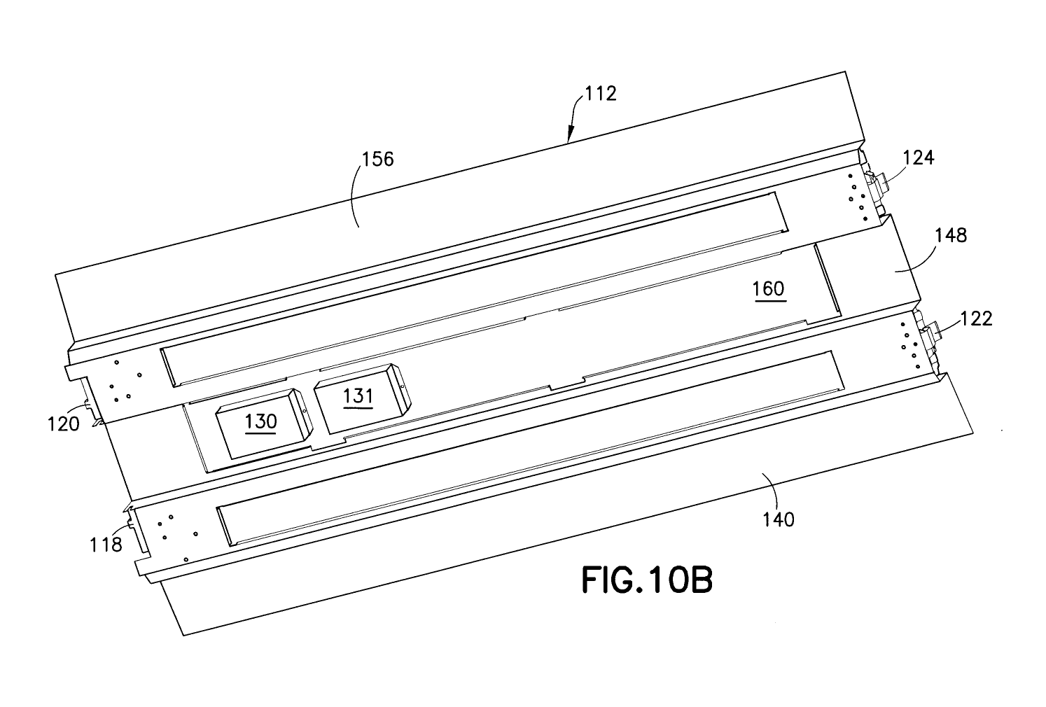

Referring to FIG. 10A, an exploded view of a LED light fixture, according to one implementation of the present disclosure, is illustrated. In this embodiment, lamp holders 118, 120 and lamp holders 122, 124 are mounted directly to the cover 112 and driver modules 130, 131 are disposed in the concealed cavity 158. The central connector plate 148 of the cover 112 includes a removable portion or cover 160 for providing access to the driver modules and/or associated wiring for the fixture. In one embodiment, the driver modules, other circuitry, batteries, etc. are mounted to the back plate 104 of the housing 102 with the removable portion or cover 158 providing access when the cover 112 is installed in the housing 102. In another embodiment, the driver modules, other circuitry, batteries, etc. are mounted to the removable portion or cover 160 and then electrically coupled, via conventional connectors, to the power and lamp holder wires. Referring to FIG. 10B, driver modules 130, 131 are mounted to the removable cover 160. In this embodiment, if the driver modules 130, 131 need to be accessed while the fixture is installed, for example, in a ceiling, the removable cover 160 is removed from the central connector plate 148 where the drive modules and/or other circuitry will be carried thereon. It is to be appreciated that sufficient lengths of wire (or other suitable conductors) will be provided between the driver modules and the power connection and lamp holders so that the removable cover 160 may be moved far enough away from the fixture 100 to facilitate replacement of the driver modules or other circuitry.

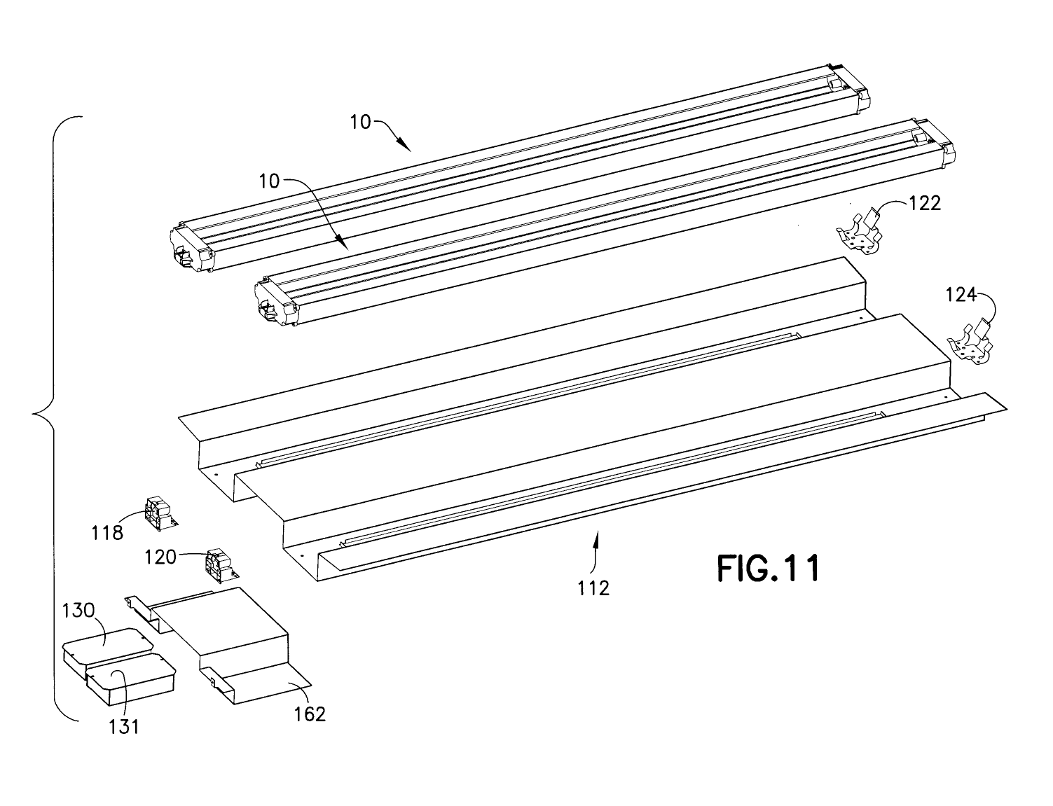

Referring to FIG. 11, an exploded view of a LED light fixture, according to another implementation of the present disclosure, is illustrated. In this embodiment, lamp holders 122, 124 are mounted directly to the cover 112. An additional bracket 162 is provided for supporting lamp holders 118, 120 and the driver modules 130, 131. It is to be appreciated that the bracket 162 conforms to the shape of the cover 112 and is coupled to the cover during the manufacturing or installation process.

It is to be appreciated that the LED lamp module and LED light fixture assembly described above according to various implementations may be employed to retrofit conventional fluorescent light fixtures. As described above, a conventional fluorescent light fixture may include a first end and a second end, with each of the first and second ends including one or more fluorescent tube lamp holders and a ballast. The fluorescent tube lamp holders and ballasts are removed and cover 112 is mounted in the fluorescent light fixture, the cover including at least one exposed, rectangular cavity 114, 116 and a concealed cavity 158. At least one driver module 130, 131 is mounted in the concealed cavity 158 and electrically coupled to at least one LED lamp module via lamp holders 118, 112. The at least one LED lamp module 10 is disposed in the at least one exposed, rectangular cavity 114, 118. Each LED lamp module 10 is supported in the cover 112 by at least one first lamp holder 118, 120 and at least one corresponding lamp holder 122, 124.

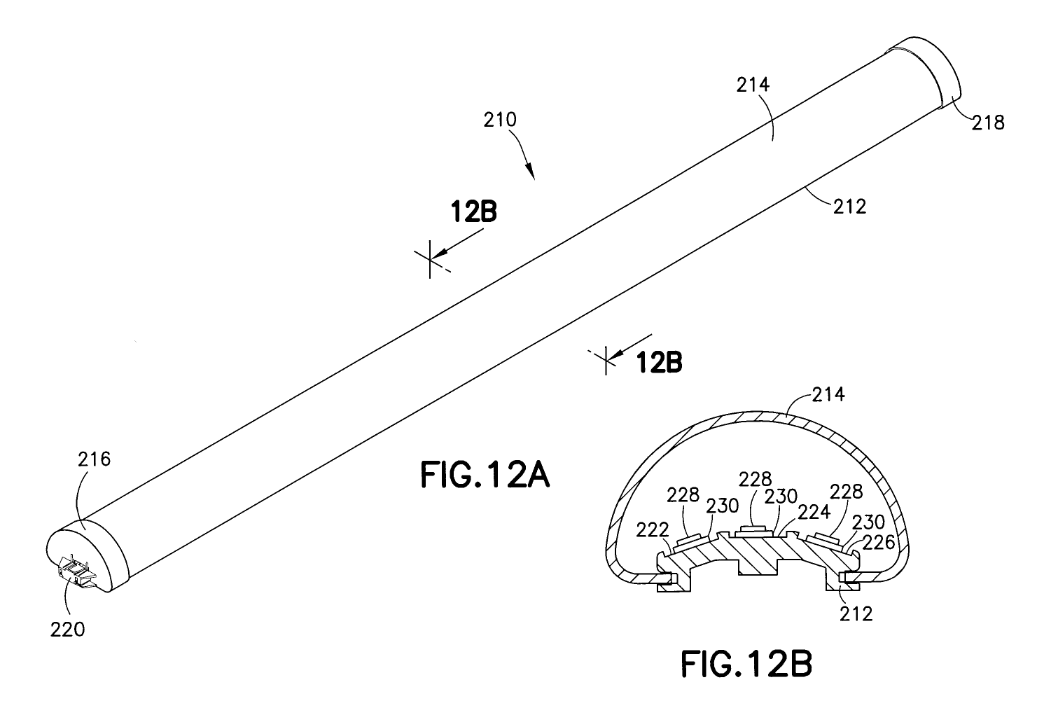

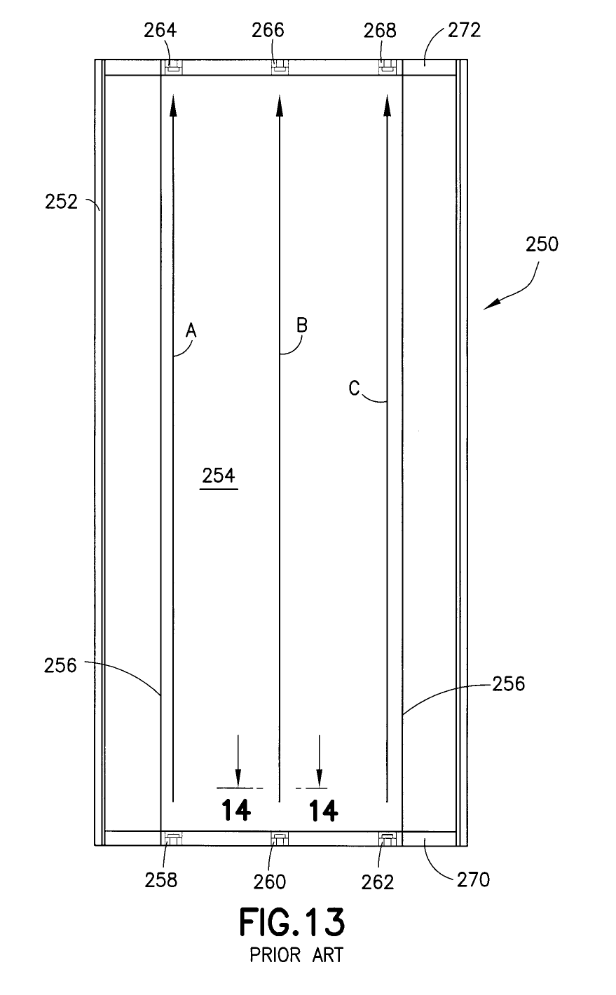

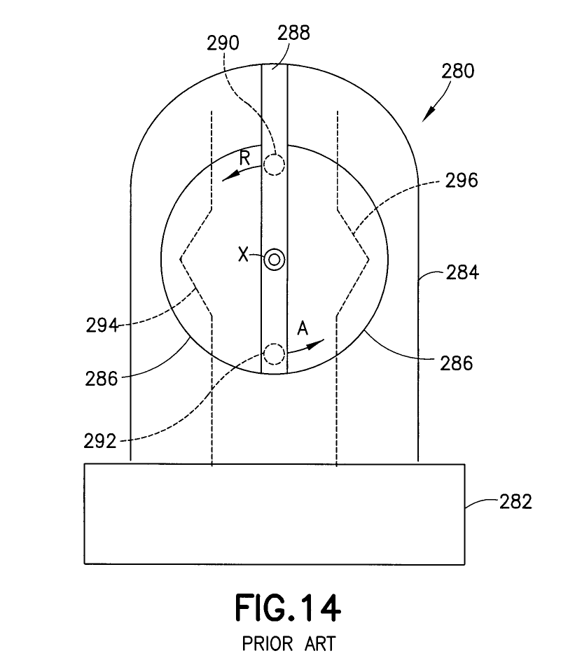

It is to be appreciated that the cover and light fixture of the present disclosure may support other LED lamp modules than those described above. Referring to FIGS. 12A and 12B, for example, another LED lamp module 210, according to various implementations of the present disclosure, is illustrated. The LED lamp module 210 includes a base 212, a diffuser 214 and first and second end caps 216, 218. It is to be appreciated that the LED lamp module 210 is dimensioned similar to LED lamp module 10 so that LED lamp module 210 may be disposed in the at least one exposed cavity 114, 116 of cover 112. It is further to be appreciated that first and second end caps 216, 218 include a guide member 220 that extends from each end cap, the guide member 220 being configured substantially similar to guide member 66 so that LED lamp module 210 may easily replace LED lamp module 10. The guide member 220 may be used to engage with a support structure, e.g., a lamp holder, a support strip, a power supply strip, etc. At least one of the first and second end caps 216, 218 will include a guide member with conductive blades electrically coupled to at least one LED disposed within the LED lamp module 210.

Referring to FIG. 12B, the LED lamp module 210 will provide direct lighting through the diffuser 214. In this embodiment, the base 212 includes three surfaces 222, 224, 226 which run the length of the LED lamp module 210. Each surface is configured to support at least one LED and, in certain embodiments, a plurality of LEDs 228 disposed on a printed circuit board 230. The LEDs 228 are positioned to face the diffuser to provide light therethrough. The three surfaces 222, 224, 226 are positioned at various angles relative to each to disperse the light emitted from the LEDS in various directions.

Regardless of the method of lighting, e.g., direct or indirect, various LED lamp modules can be configured or adapted to be employed in the covers and/or light fixtures described above by dimensioning the LED lamp module to be disposed in the at least one exposed cavity 114, 116 of cover 112 and by providing end caps on the LED lamp module according to the various embodiments described above.

It is to be appreciated that the various features shown and described are interchangeable, that is a feature shown in one embodiment may be incorporated into another embodiment.

The various implementations described herein are not intended to limit the present disclosure, but may include additional features and advantages not necessarily expressed herein. The additional features and advantages may be apparent to one of ordinary skill in the art upon examination of the detailed description and accompanying drawings, according to spirit and scope of the present disclosure. It is intended that all such additional features and advantages be included within the present disclosure and protected by the accompanying claims.

I/we claim:

1. A light emitting diode (LED) lamp module comprising:
an elongated housing having a first end and a second end, the housing including a first wall and first and second side walls extending substantially perpendicular from at least a portion of the first wall, each of the first and second side walls including a flange portion extending toward an opposing side wall and being generally parallel to at least a portion of the first wall, the flange portions defining an opening therebetween; and
at least one LED disposed on an inner side of each of the flange portions, the at least one LED facing the first wall such that light is transmitted from the at least one LED towards the first wall and at least partially reflected out of the LED lamp module through the opening.

2. The LED lamp module of claim 1, further comprising a diffuser disposed across the opening and coupled to each of the flange portions.

3. The LED lamp module of claim 2, wherein each flange portion includes a channel configured to receive an edge of the diffuser.

4. The LED lamp module of claim 2, wherein the diffuser includes a transparent or translucent material.

5. The LED lamp module of claim 1, further comprising a reflective material disposed on at least one internal surface of the housing.

6. The LED lamp module of claim 1, wherein the at least one LED includes a linear array of LEDs disposed on a printed circuit board.

7. The LED lamp module of claim 6, wherein the linear array of LEDs is coupled to the inner side of the flange portion by thermal tape.

8. The LED lamp module of claim 6, wherein the housing is constructed from a thermally conductive material and acts as a heat sink for the at least one LED.

9. The LED lamp module of claim 1, further comprising a first end cap coupled to the first end of the housing and a second end cap coupled to the second end of the housing.

10. The LED lamp module of claim 9, wherein each of the first and second end caps includes a guide member extending therefrom configured to engage a support structure of a light fixture.

11. The LED lamp module of claim 10, wherein at least one of the first and second end caps includes at least one conductive blade electrically coupled to the at least one LED.

12. A light emitting diode (LED) fixture assembly comprising:
at least one cover configured to be disposed in a fluorescent light troffer, the at least one cover including at least one first cavity and a second cavity;
at least one LED lamp module disposed in the at least one first cavity; and
a driver module disposed in the second cavity such that the driver module is visibly concealed and electrically coupled to at least one LED lamp, the driver module configured to provide electrical power to the at least one LED lamp module,
wherein the second cavity includes a removable portion for providing access to the driver module disposed therein.

13. The LED fixture assembly of claim 12, further comprising at least one first lamp holder disposed in a first end of the at least one first cavity and at least one corresponding second lamp holder disposed in a second end of the at least one first cavity.

14. The LED fixture assembly of claim 13, wherein the at least one first lamp holder includes at least one receptacle, each receptacle including an electrically conductive contact disposed therein configured to provide electrical power to the least one LED lamp module.

15. The LED fixture assembly of claim 14, wherein the at least one first lamp holder further includes alignment blocks configured to align a first end of the at least one LED lamp module into the at least one first lamp holder such that at least one contact of the LED lamp module is inserted into the at least one receptacle.

16. The LED fixture assembly of claim 14, wherein the at least one corresponding second lamp holder includes a flexible latch configured to releasably secure a second end of the at least one LED lamp module.

17. The LED fixture assembly of claim 14, wherein the driver module is electrically coupled to the contact in the at least one receptacle of the at least one first lamp holder.

18. The LED fixture assembly of claim 12, wherein the driver module is coupled to the fluorescent light troffer.

19. The LED fixture assembly of claim 12, wherein the driver module is coupled to the removable portion.

20. The LED fixture assembly of claim 12, wherein the at least one LED lamp module comprises:
an elongated housing having a first end and a second end, the housing including a first wall and first and second side walls extending substantially perpendicular from at least a portion of the first wall, each of the first and second side walls including a flange portion extending toward an opposing side wall and being generally parallel to at least a portion of the first wall, the flange portions defining an opening along the housing;
at least one LED disposed on an inner side of each of the flange portions, the at least one LED facing the first wall such that light is transmitted from the at least one LED towards the first wall and at least partially reflected out of the LED lamp module thru through the opening; and
a diffuser disposed across the opening and coupled to each of the flange portions.

21. The LED fixture assembly of claim 13, wherein the at least one LED lamp module further comprises a first end cap coupled to the first end and a second end cap coupled to the second end, wherein each of the first and second end cap includes a guide member extending therefrom configured to engage the at least one first lamp holder and the at least one corresponding second lamp holder.

22. The LED fixture assembly of claim 21, wherein at least one of the first and second end caps includes at least one conductive blade electrically coupled to at least one LED disposed in the at least one LED lamp module.

23. A method of retrofitting an existing fluorescent light troffer to a light emitting diode (LED) light fixture, the method comprising:
removing one or more fluorescent tube lamp holders and a ballast from the existing fluorescent light troffer;
mounting at least one cover in the fluorescent light troffer, the cover including at least one first cavity and a second cavity;
mounting a driver module in the second cavity for electrically coupling the driver module to at least one LED lamp module, the driver module being visibly concealed within the second cavity of the cover when mounted, the driver module configured to provide electrical power to the at least one LED lamp module; and
inserting the at least one LED lamp module in the at least one first cavity.

24. The method of claim 23, further comprising providing at least one first lamp holder disposed in a first end of the at least one first cavity and at least one corresponding second lamp holder disposed in a second end of the at least one first cavity, the at least one first lamp holder and the at least one corresponding second lamp holder for supporting a first and second end of the at least one LED lamp module.

25. The method of claim 24, wherein the at least one first lamp holder includes at least one receptacle, each receptacle including an electrically conductive contact disposed therein and coupled to the drive module for providing power to the first end of the at least one LED lamp module.

26. The method of claim 25, wherein the at least one corresponding second lamp holder includes a flexible latch configured to releasably secure the second end of the at least one LED lamp module.
